(19) United States
(12) Patent Application Publication
(10) Pub. No.: US 2026/0030312 A1
(43) Pub. Date: Jan. 29, 2026

(54) SIMILARITY CALCULATION DEVICE, SIMILARITY CALCULATION METHOD AND SIMILARITY CALCULATION PROGRAM

(71) Applicant: NIPPON TELEGRAPH AND TELEPHONE CORPORATION, Tokyo (JP)

(72) Inventors: Fumihiro YOKOSE, Tokyo (JP); Kimio TSUCHIKAWA, Tokyo (JP); Taisuke WAKASUGI, Tokyo (JP); Ryo UCHIDA, Tokyo (JP); Haruo OISHI, Tokyo (JP)

(21) Appl. No.: 18/993,528

(22) PCT Filed: Jul. 13, 2022
(86) PCT No.: PCT/JP2022/027612

§ 371 Date: Jan. 11, 2025

(51) Int. Cl. G06F 16/955; G06F 11/34

(52) U.S. Cl. CPC G06F 16/9566; G06F 11/34

(57) ABSTRACT

An extraction unit (15c) extracts a part representing an ID from each of two processing target URLs contained in an operation log. A determination unit (15d) determines whether or not the part representing the ID is a temporarily generated part, by using statistical information in operation logs for a predetermined period. A calculation unit (15e) calculates similarity between the two processing target URLs by excluding the part representing the ID in a case where the part representing the ID is a temporarily generated part.

### TECHNICAL FIELD

The present invention relates to a similarity calculation apparatus, a method for calculating similarity, and a similarity calculation program.

### BACKGROUND ART

In operation automation on a PC such as robotic process automation (RPA) or operation analysis on a PC, it is necessary to determine identicalness between web pages. At that time, various types of information such as window titles or page content are comprehensively used, and a uniform resource locator (URL) is particularly important information.

In recent years, since web sites have fulfilled sophisticated functions and had complicated mechanisms, and URLs representing individual web pages constituting the web sites have come to include various items of information, the URLs change even in the same web page in some cases. Hence, regarding comparison of the URLs necessary for determining identicalness between the web pages, it is not possible to make a determination only by whether the URLs are completely identical or are not identical, and it is necessary to make a determination in consideration of the similarity of the URLs. Conventionally, the degree of similarity of URLs is evaluated using a matching percentage, an edit distance (Levenshtein distance), or the like by comparing character strings of the URLs from the front (see Non Patent Literature 1).

### CITATION LIST

### Non Patent Literature

Non Patent Literature 1: Fumihiro Yokose, Sayaka Yagi, Haruo Oishi, “Proposal for PC Operation Automation Support Interlocked with Operator's Situations”, IEICE Technical Report, March 2022, vol. 121, no. 399, ICM2021-49, pp. 41-46

### SUMMARY OF INVENTION

### Technical Problem

However, in the related art, the closeness of actual URLs is not sufficiently reflected in the similarity in some cases. For example, in a case where system-specific IDs are contained in URLs, it is difficult to correctly evaluate the similarity between web pages.

The present invention has been made in view of the above description, and an object of the present invention is to enable similarity between URLs to be evaluated with high accuracy to be used in determination of identicalness between web pages.

### Solution to Problem

In order to solve the above-described problems and achieve the object, a similarity calculation apparatus according to the present invention includes: an extraction unit that extracts a part representing an ID from each of two processing target URLs contained in an operation log; a determination unit that determines whether or not the part representing the ID is a temporarily generated part by using statistical information in operation logs for a predetermined period; and a calculation unit that calculates similarity between the two processing target URLs by excluding the part representing the ID in a case where the part representing the ID is a temporarily generated part.

### Advantageous Effects of Invention

According to the present invention, it is possible to evaluate identicalness between web pages with high accuracy in consideration of similarity between URLs.

### BRIEF DESCRIPTION OF DRAWINGS

FIG. 1 is a diagram for describing an outline of a similarity calculation apparatus.

FIG. 2 is a diagram for describing an outline of the similarity calculation apparatus.

FIG. 3 is a schematic diagram illustrating a schematic configuration of the similarity calculation apparatus.

FIG. 4 is a diagram for describing processing of a deconstruction unit.

FIG. 5 is a diagram for describing processing of an extraction unit and a determination unit.

FIG. 6 is a diagram for describing processing of the extraction unit and the determination unit.

FIG. 7 is a flowchart illustrating a similarity calculation processing procedure.

FIG. 8 is a diagram illustrating an example of a computer that executes a similarity calculation program.

### DESCRIPTION OF EMBODIMENTS

Hereinafter, an embodiment of the present invention will be described in detail with reference to the drawings. Note that the present invention is not limited by this embodiment. In addition, in the description of the drawings, the same portions are denoted by the same reference numerals.

### Outline of Similarity Calculation Device

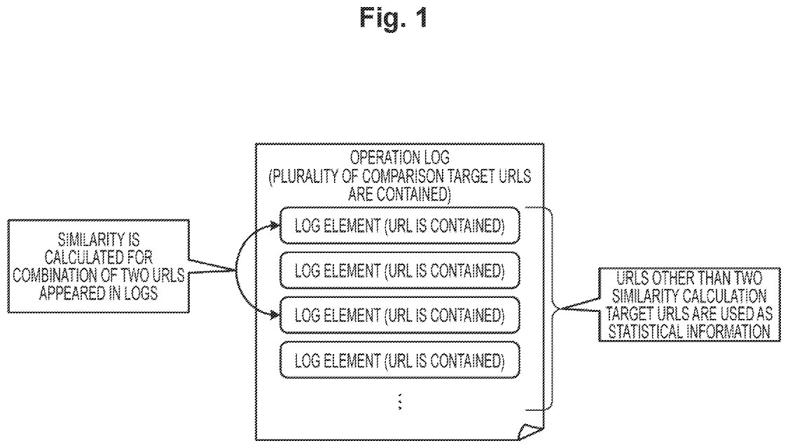

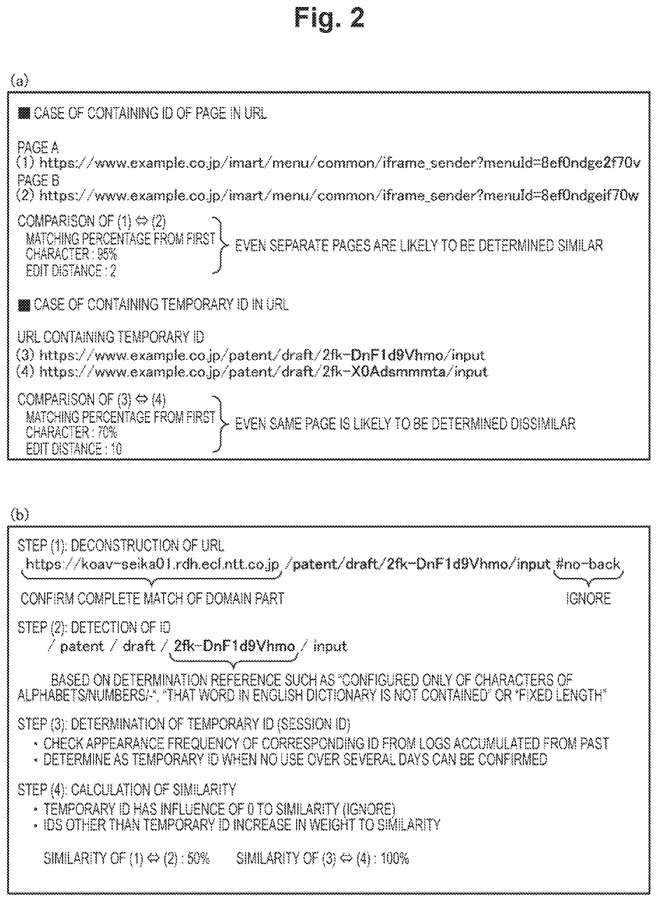

FIGS. 1 and 2 are diagrams for describing an outline of a similarity calculation apparatus. The similarity calculation apparatus calculates similarity of character strings between URLs in order to determinate identicalness between the web pages or the like. For example, as illustrated in FIG. 1, any two URLs contained in an operation log are compared to calculate similarity. At that time, the similarity calculation apparatus accurately evaluates the similarity between the URLs by statistically using past operation logs.

Here, conventionally, when URLs are compared, similarity is evaluated by using a matching percentage from first characters of character strings of the URLs or an edit distance (Levenshtein distance) representing the number of procedures necessary for replacement. However, in a case where system-specific IDs are contained in the URLs, it is not possible to evaluate semantic closeness of the actual URLs.

For example, as illustrated in FIG. 2 (a), in a case where some ID is contained in URLs, it is determined that even different web pages are similar, that is, have high similarity, in some cases. In addition, in a case where a temporary ID that is generated to be temporarily used and discarded is contained in URLs, it is determined that even the same web page is dissimilar, that is, have low similarity, in some cases.

In this respect, as illustrated in FIG. 2 (b), the similarity calculation apparatus according to the present embodiment deconstructs a URL into elements according to the http/https scheme syntax and detects an ID part in the URL in consideration of characteristics of the ID. Then, the similarity calculation apparatus determines that the detected ID is a temporary ID such as a session ID in consideration of an appearance frequency in past logs, for example, in a case where the detected ID is not reused over several days.

Here, many temporary IDs are IDs used for managing sessions and are not related to identicalness between web pages indicated by URLs in many cases. On the other hand, other permanent IDs are strongly related to web pages indicated by URLs in many cases. In this respect, the similarity calculation apparatus assumes that the temporary ID does not affect similarity between two evaluation target URLs and calculates the similarity between the two URLs by increasing weight of the other permanent IDs on the similarity.

In this manner, the similarity calculation apparatus can highly accurately determine similarity between URLs which is necessary for determining identicalness between web pages. Note that a processing target of the similarity calculation apparatus is not limited to the URL and may be a uniform resource identifier (URI) or a uniform resource name (URN).

### Configuration of Similarity Calculation Apparatus

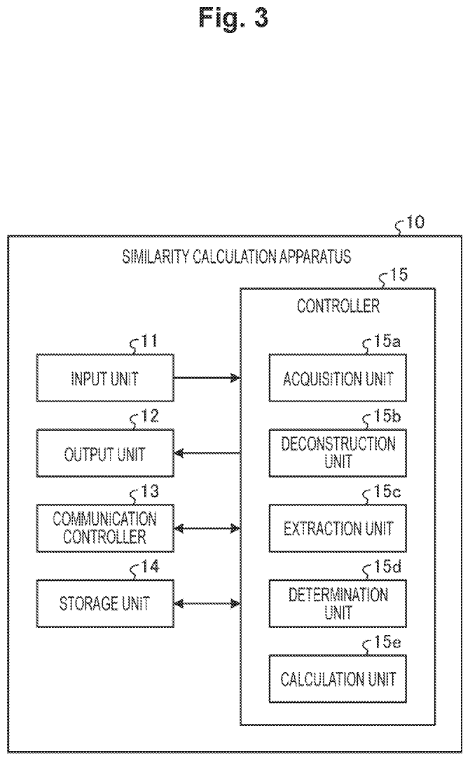

FIG. 3 is a schematic diagram illustrating a schematic configuration of the similarity calculation apparatus. As illustrated in FIG. 3, the similarity calculation apparatus 10 of the present embodiment is realized by a general-purpose computer such as a personal computer and includes an input unit 11, an output unit 12, a communication controller 13, a storage unit 14, and a controller 15.

The input unit 11 is realized with an input device such as a keyboard or a mouse and inputs various types of instruction information such as a processing start to the controller 15 in response to an input operation of an operator. The output unit 12 is realized with a display device such as a liquid crystal display, a printing device such as a printer, or the like. For example, the output unit 12 displays a result of similarity calculation processing to be described below.

The communication controller 13 is realized with a network interface card (NIC) or the like and controls communication between an external device and the controller 15 via a telecommunication line such as a local area network (LAN) or the Internet. For example, the communication controller 13 controls communication between the controller 15 and a management device or the like that manages an operation log.

The storage unit 14 is realized with a semiconductor memory element such as a random access memory (RAM) or a flash memory, or a storage device such as a hard disk or an optical disc. In the storage unit 14, a processing program for operating the similarity calculation apparatus 10, data to be used during execution of the processing program, or the like is stored in advance or is temporarily stored each time processing is performed. Note that the storage unit 14 may be configured to communicate with the controller 15 via the communication controller 13.

The controller 15 is realized with a central processing unit (CPU) or the like and executes the processing program stored in a memory. Consequently, as illustrated in FIG. 3, the controller 15 functions as an acquisition unit 15a, a deconstruction unit 15b, an extraction unit 15c, a determination unit 15d, and a calculation unit 15e and executes the similarity calculation processing. Note that each or some of these functional units may be installed in different sets of hardware. For example, the calculation unit 15e may be installed in a different set of hardware separately from the other functional units. In addition, the controller 15 may also include other functional units.

The acquisition unit 15a acquires processing target operation logs for a predetermined period. For example, the acquisition unit 15a acquires the processing target operation logs via the input unit 11 or from a management device or the like via the communication controller 13.

Note that the acquisition unit 15a may acquire the processing target operation logs in advance and may store the operation logs in the storage unit 14 or may immediately transfer the operation logs to a subsequent functional unit without storing the operation logs in the storage unit 14.

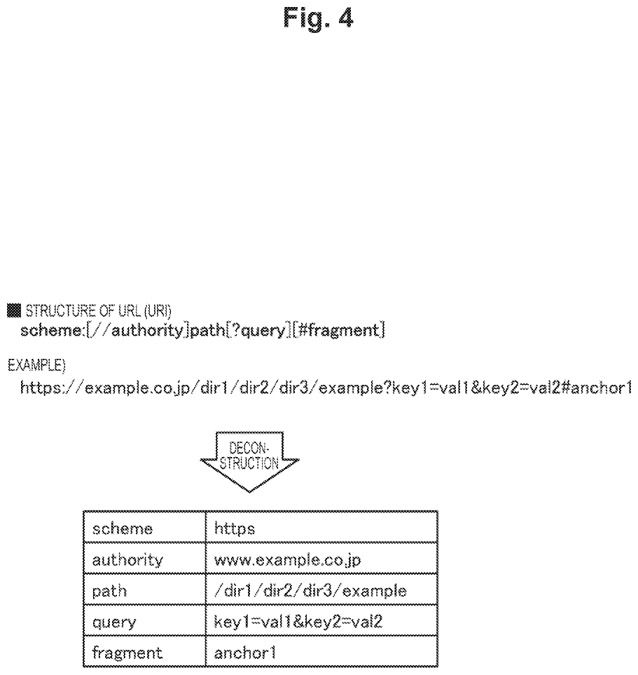

The deconstruction unit 15b deconstructs URLs contained in the processing target operation logs into elements of the scheme syntax. Here, FIG. 4 is a diagram for explaining processing performed by the deconstruction unit. As illustrated in FIG. 4, the deconstruction unit 15b deconstructs each URL into scheme, authority, path, query, and fragment according to http/https scheme syntax.

Here, the scheme is either http or https in which whether or not communication encryption is performed is different, and can be ignored in the calculation of the similarity of URLs. However, for example, in the case of different schemes, the schemes may be used in calculation of the similarity of the URLs such as uniformly setting the similarity to 0.

The authority is a part representing a host name, and similarity is calculated in a case where parts of the authority exactly match, and the similarity is set to 0 in a case where the parts of the authority do not exactly match.

The authority includes user information or a port number in some cases. Since a difference in user information does not affect content of web pages in many cases, the user information is ignored when the similarity is calculated. In the case of standard port numbers (80 for http and 443 for https), the port numbers are ignored when the similarity is calculated. On the other hand, in the case of a port number other than the standard port numbers, similarity is calculated by analyzing the port number as part of the host name.

The fragment is a part representing an anchor in a web page, and a difference in the fragment does not affect a difference in the web page and thus is ignored when the similarity is calculated. However, the fragment may be considered when the similarity is calculated.

Description will here return to FIG. 3. The extraction unit 15c extracts a part representing an ID from each of two processing target URLs contained in an operation log. Specifically, the extraction unit 15c extracts the part representing the ID from a part constituting a path or a query of each of the two processing target URLs. That is, the extraction unit 15c extracts the part representing the ID from the path or the query of the URL elements deconstructed by the deconstruction unit 15b. At that time, the extraction unit 15c performs decoding if percent-encoding (URL encoding) is contained.

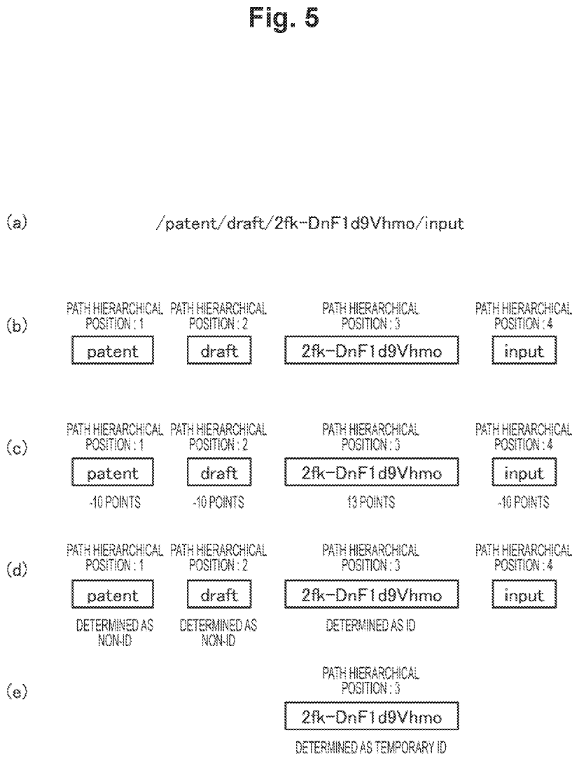

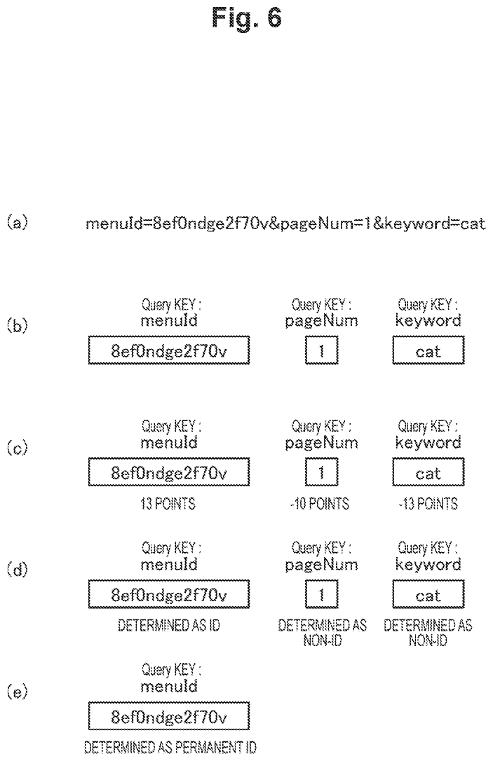

Here, FIGS. 5 and 6 are diagrams for describing processing of the extraction unit and the determination unit. FIG. 5 illustrates processing of extracting a part representing an ID from a part constituting a URL path. In addition, FIG. 6 illustrates processing of extracting the part representing the ID from a part constituting a URL query.

First, as illustrated in FIG. 5, the extraction unit 15c extracts the part representing the ID from the part constituting the URL path. Specifically, as illustrated in FIG. 5 (b), the extraction unit 15c extracts character substrings divided by “/” and hierarchical positions from the front thereof, from the part constituting the URL path illustrated in FIG. 5 (a).

Next, as illustrated in FIG. 5 (c), the extraction unit 15c calculates an ID determination score for each character substring. Here, the ID determination score is a score obtained by scoring each character substring in accordance with a predetermined rule and a predetermined score distribution. Then, in a case where the ID determination score is, for example, a predetermined threshold (0 in the present embodiment) or higher, the extraction unit 15c determines that this character substring represents some kind of ID. Consequently, as illustrated in FIG. 5 (d), the extraction unit 15c determines that each character substring is an ID or a non-ID.

Examples of rules for the path include the following non-statistical rules and statistical rule. First, the following four non-statistical rules are provided as examples. In accordance with the following non-statistical rule (1), a dictionary of English words including proper nouns or inflected forms such as past forms is prepared in advance.
(1) Subtract ten points from the ID determination score in a case where four or more English words are included.
(2) Add five points to the ID determination score in a case where a number and an alphabet are mixed.
(3) Subtract three points from the ID determination score in a case where the number of characters is three or less.
(4) Subtract three points from the ID determination score in a case where a half-width or full-width space is included.

In addition, the statistical rule is used to determine whether or not a target character substring is an ID by using statistical information in a set of URLs contained in all operation logs. For example, in the set of URLs contained in all the operation logs, the statistical information in a subset of URLs having the same authority character string and the same character substring at a hierarchical position higher than the hierarchical position of the path is used. That is, in this subset, in a case where a plurality of candidates in which all the character substrings have the same character string length are present for the character substring at the hierarchical position of the path, eight points are added to the ID determination score.

In addition, as illustrated in FIG. 6, the extraction unit 15c extracts a part representing an ID from a part constituting the URL query. Specifically, as illustrated in FIG. 6 (b), the extraction unit 15c extracts a character substring representing a value of a key divided by “=” and “&” from the part constituting the URL query illustrated in FIG. 6 (a).

Here, a structure of a character string of the query includes Type 1 and Type 2. Type 1 has a structure in which keys and values are combined with “=” and the keys are connected with “&”, for example, “key1=val1&key2=val2& . . . ”. In this case, the extraction unit 15c extracts vol1 of key1, vol2 of key2, . . . , and a positions of a value is identified by a corresponding key.

In addition, Type 2 has a structure in which there is no key and values are connected with “&”, for example, “vol1&vol2& . . .”. In this case, the extraction unit 15c extracts vol1, vol2, . . . , and a position of a value is identified in the arrangement order. Note that a case of one value is Type 2.

Next, as illustrated in FIG. 6 (c), the extraction unit 15c calculates an ID determination score for each character substring. Then, in a case where the ID determination score is, for example, a predetermined threshold (0 in the present embodiment) or higher, the extraction unit 15c determines that this character substring represents some kind of ID. Consequently, as illustrated in FIG. 6 (d), the extraction unit 15c determines that each character substring is an ID or a non-ID.

Similarly to the ID determination score for the path, the ID determination score for the character substring is a score obtained by scoring each character substring by a predetermined rule for the query and a predetermined score distribution. As rules for the query, non-statistical rules and a statistical rule are provided similarly to the rules for the path. Of the rules, the non-statistical rules are similar to the non-statistical rules for the path.

Similarly to the statistical rule for the path, the statistical rule for the query of Type 1 determines whether or not a target character substring is an ID by using statistical information in a set of URLs contained in all operation logs. For example, in the set of the URLs contained in all the operation logs, statistical information in a subset of the URLs in which the authority character strings and the path character strings match and corresponding query keys are contained is used. That is, in this subset, in a case where a plurality of candidates in which all the character substrings have the same character string length are present for a value associated with a corresponding key, eight points are added to the ID determination score.

Similarly, the statistical rule for the query of Type 2 uses, for example, statistical information in a subset of URLs in which the authority character strings and the path character strings match in the set of the URLs contained in all the operation logs. That is, in this subset, in a case where a plurality of candidates in which all the character substrings have the same character string length are present for a value associated with a corresponding position, eight points are added to the ID determination score.

Note that the extraction unit 15c may determine whether or not a character substring is an ID by using other parameters. In addition, a process of determining whether or not a character substring is an ID by the extraction unit 15c is not limited to the description provided above. For example, the ID determination score may be obtained using only the non-statistical rules. Alternatively, the processing of the statistical rule may be performed before processing of the non-statistical rules to improve the efficiency of the calculation amount.

Description will here return to FIG. 3. The determination unit 15d determines whether or not a part representing an ID is a temporarily generated part, by using statistical information in operation logs for a predetermined period. Here, a part representing an ID that is generated to be temporarily used and discarded, such as a session ID of communication, is set as a temporary ID. In addition, in other cases, a part representing an ID having a permanent significance without being changed by an access timing or the like is set as a permanent ID.

The determination unit 15d determines whether an ID is the temporary ID or the permanent ID by using the statistical information in the set of URLs contained in all the operation logs. For example, the determination unit 15d determines whether or not a part is a temporarily generated part, by using the number of appearances of the part representing an ID in operation logs for a predetermined period. Specifically, the determination unit 15d determines that the part representing an ID is not the temporarily generated part in a case where the part representing the ID appears twice or more over a predetermined time interval in the operation logs for the predetermined period.

For example, as illustrated in FIG. 5 (e), the determination unit 15d determines whether a part representing an ID extracted from a part constituting a URL path is the temporary ID or the permanent ID. That is, the determination unit 15d uses the statistical information in a subset of URLs having the same authority character string and the same character substring at a hierarchical position higher than the hierarchical position of the path in a set of URLs contained in all the operation logs. For example, in a case where the same character substring representing an ID of the hierarchical position of the path appears twice or more at intervals of 12 hours or longer in the subset, the determination unit 15d determines the character substring representing the ID as the permanent ID. In addition, the determination unit 15d determines a character substring representing another ID as the temporary ID.

In addition, as illustrated in FIG. 6 (e), the determination unit 15d determines whether a part representing an ID extracted from a part constituting a URL query is the temporary ID or the permanent ID. That is, regarding the query of Type 1, the determination unit 15d uses the statistical information in the subset of the URLs in which the authority character strings and the path character strings match and corresponding query keys are contained in the set of the URLs contained in all the operation logs. For example, in a case where a value associated with a corresponding key appears twice or more at intervals of 12 hours or longer in the subset, the determination unit 15d determines the character substring representing the ID as the permanent ID. In addition, the determination unit 15d determines a character substring representing another ID as the temporary ID.

In addition, regarding the query of Type 2 uses, the determination unit 15d uses statistical information in a subset of URLs in which the authority character strings and the path character strings match in the set of the URLs contained in all the operation logs. For example, in a case where a value associated with a corresponding position appears twice or more at intervals of 12 hours or longer in the subset, the determination unit 15d determines the character substring representing the ID as the permanent ID. In addition, the determination unit 15d determines a character substring representing another ID as the temporary ID.

Note that the determination unit 15d may determine a part representing an ID by a binary value such as a temporary ID/permanent ID as described above or may determine the part by a value having a width such as 0% to 100% (0.0 to 1.0).

Description will here return to FIG. 3. The calculation unit 15e calculates similarity between two processing target URLs by excluding a part representing a corresponding ID in a case where the part representing the ID is a temporarily generated part. In addition, the calculation unit 15e calculates similarity between two processing target URLs by adding a predetermined weight to a part representing a corresponding ID in a case where the part representing the ID is a temporarily generated part.

Specifically, first, in a case where authority parts of the two processing target URLs do not completely match, the calculation unit 15e sets the similarity to 0.

In addition, in a case where the authority parts of the two processing target URLs completely match, the calculation unit 15e initializes variables of a “similarity point” and a “maximum similarity point” to 0.

Next, the calculation unit 15e compares elements determined to be non-IDs in the character substrings of the path/query for each position and adds 1 to the “similarity point” in the case of perfect match. In this case, in a case where no character substring is contained at the position corresponding to one URL, it is assumed that a NULL character string is contained and the match is not perfect.

In addition, the calculation unit 15e adds, to the “maximum similarity point”, the number of times of comparison of the elements determined to be non-IDs in the character substrings of the path/query.

Next, the calculation unit 15e compares elements determined to be permanent IDs in the character substrings of the path/query for each position and adds 2 to the “similarity point” in the case of perfect match. In this case, in a case where no character substring is contained at the position corresponding to one URL, it is assumed that a NULL character string is contained and the match is not perfect.

In addition, the calculation unit 15e allows the number of times of comparison of the elements determined to be permanent IDs in the character substrings of the path/query to be weighted twice and adds the weighted result to the “maximum similarity point”.

Then, the calculation unit 15e calculates “similarity point”÷ “maximum similarity point” as the similarity. In this manner, the calculation unit 15e excludes the temporary ID from comparison targets of the similarity, adds a predetermined weight to the permanent ID, and calculates the similarity between the two URLS.

### Similarity Calculation Processing

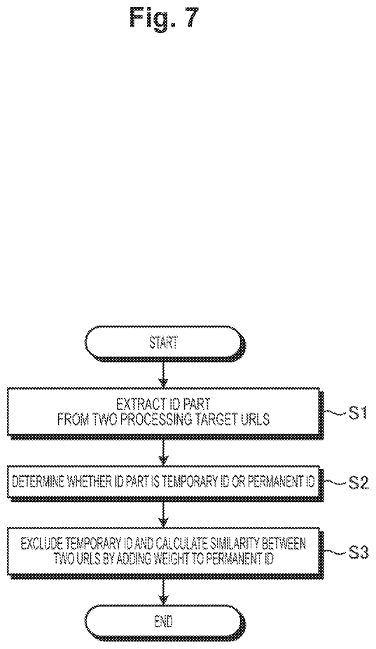

Next, with reference to FIG. 7, similarity calculation processing executed by the similarity calculation apparatus 10 according to the present embodiment will be described. FIG. 7 is a flowchart illustrating a similarity calculation processing procedure. The flowchart of FIG. 7 is started, for example, at a timing when a user gives an instruction to start the apparatus.

First, the acquisition unit 15a acquires the processing target operation logs for the predetermined period, and the deconstruction unit 15b deconstructs the URLs contained in the processing target operation logs into elements of scheme syntax. In addition, the extraction unit 15c extracts a part representing an ID from each of two processing target URLs contained in the operation logs (step S1).

Specifically, the extraction unit 15c extracts the part representing the ID from a part constituting a path or a query of each of the two processing target URLs. That is, the extraction unit 15c extracts the part representing the ID from the path or the query of the URL elements deconstructed by the deconstruction unit 15b.

Next, the determination unit 15d determines whether the part indicating the ID is the temporarily generated temporary ID or the permanent ID by using the statistical information in the set of the URLs contained in all the operation logs for the predetermined period (step S2).

For example, the determination unit 15d determines whether the part representing the ID is the temporary ID or the permanent ID, by using the number of appearances of the part representing the ID in the operation logs for the predetermined period. Specifically, the determination unit 15d determines that the part representing the ID is the permanent ID in the case where the part representing the ID appears twice or more over the predetermined time interval in the operation logs for the predetermined period.

Then, the calculation unit 15e excludes the temporary ID from comparison targets of the similarity, adds the predetermined weight to the permanent ID, and calculates the similarity between the two URLs (step S3). Consequently, a series of similarity calculation processing ends.

### Effects

As described above, in the similarity calculation apparatus 10 according to the present embodiment, the extraction unit 15c extracts the part representing the ID from each of the two processing target URLs contained in the operation logs. The determination unit 15d determines whether or not the part representing the ID is the temporarily generated part, by using the statistical information in the operation logs for the predetermined period. The calculation unit 15e calculates similarity between the two processing target URLs by excluding the part representing the corresponding ID in the case where the part representing the ID is a temporarily generated part.

Specifically, the extraction unit 15c extracts the part representing the ID from a part constituting a path or a query of each of the two processing target URLs. For example, the determination unit 15d determines whether or not a part is the temporarily generated part, by using the number of appearances of the part representing the ID in the operation logs for the predetermined period. For example, the determination unit 15d determines that the part representing the corresponding ID is not the temporarily generated part in the case where the part representing the ID appears twice or more over a predetermined time interval in the operation logs for the predetermined period.

In this way, the similarity calculation apparatus 10 uses the non-statistical rules and the statistical rule to determine the temporary ID that does not affect the similarity between the two evaluation target URLs, and calculates the similarity between the two URLs by excluding the temporary ID. Consequently, the similarity calculation apparatus 10 can highly accurately determine the similarity between the URLs which is necessary for determining identicalness between web pages.

In addition, the calculation unit 15e calculates the similarity between two processing target URLs by adding the predetermined weight to the part representing the corresponding ID in the case where the part representing the ID is the temporarily generated part. Consequently, the similarity calculation apparatus 10 can calculate the similarity between URLs with higher accuracy.

### Program

It is also possible to produce a program that describes, in a computer executable language, the processing executed by the similarity calculation apparatus 10 according to the embodiment stated above. As an embodiment, the similarity calculation apparatus 10 can be implemented by installing, as packaged software or online software, a similarity calculation program for executing the above similarity calculation processing in a desired computer. For example, by causing an information processing apparatus to execute the above similarity calculation program, the information processing apparatus can be caused to function as the similarity calculation apparatus 10. The information processing device described here includes a desktop or laptop personal computer. In addition, the category of the information processing device includes a mobile communication terminal such as a smartphone, a mobile phone, or a personal handyphone system (PHS), a slate terminal such as a personal digital assistant (PDA), and the like. In addition, the functions of the similarity calculation apparatus 10 may be implemented in a cloud server.

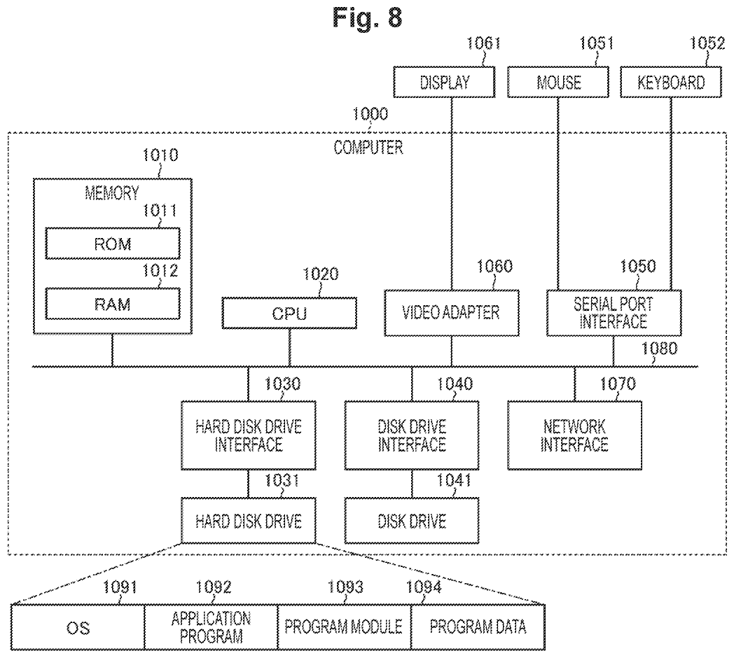

FIG. 8 is a diagram illustrating an example of a computer that executes the similarity calculation program. A computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1051 and a keyboard 1052. The video adapter 1060 is connected to, for example, a display 1061.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

In addition, the similarity calculation program is stored in the hard disk drive 1031 as the program module 1093 in which commands to be executed by the computer 1000, for example, are described. In particular, the program module 1093 in which each piece of the processing executed by the similarity calculation apparatus 10 described in the embodiment above is described is stored in the hard disk drive 1031.

In addition, data used for information processing executed by the similarity calculation program is stored as the program data 1094 in the hard disk drive 1031, for example. The CPU 1020 then reads the program module 1093 and the program data 1094 stored in the hard disk drive 1031 to the RAM 1012, as necessary, and executes each procedure described above.

The program module 1093 and the program data 1094 related to the similarity calculation program are not limited to being stored in the hard disk drive 1031, and may be stored in, for example, a removable storage medium and read by the CPU 1020 via the disk drive 1041 or the like. Alternatively, the program module 1093 and the program data 1094 related to the similarity calculation program may be stored in another computer connected via a network such as a LAN or a wide area network (WAN) and read by the CPU 1020 via the network interface 1070.

Although the embodiments to which the invention made by the present inventors is applied have been described above, the present invention is not limited by the description and the drawings forming a part of the disclosure of the present invention according to the present embodiments. That is, other embodiments, examples, operation techniques, and the like made by those skilled in the art or the like on the basis of the present embodiment are all contained in the scope of the present invention.

### REFERENCE SIGNS LIST

10 Similarity calculation apparatus
11 Input unit
12 Output unit
13 Communication controller
14 Storage unit
15 Controller
15a Acquisition unit
15b Deconstruction unit
15c Extraction unit
15d Determination unit
15e Calculation unit

1. A similarity calculation apparatus comprising:
an extraction unit configured to extract a part representing an identification (ID) from each of two processing target uniform resource locators (URLs) contained in an operation log;
a determination unit configured to determine whether or not the part representing the ID is temporarily generated, by using statistical information in operation logs for a predetermined period; and
a calculation unit configured to calculate similarity between the two processing target URLs by excluding the part representing the ID when the part representing the ID is determined to be temporarily generated.

2. The similarity calculation apparatus according to claim 1, wherein the determination unit is configured to determine whether or not the part is temporarily generated by using the number of appearances of the part representing the ID in the operation logs for the predetermined period.

3. The similarity calculation apparatus according to claim 2, wherein the determination unit is configured to determine that the part representing the ID is not temporarily generated when the part representing the ID appears twice or more over a predetermined time interval in the operation logs for the predetermined period.

4. The similarity calculation apparatus according to claim 1, wherein, when the part representing the ID is not determined to be temporarily generated, the calculation unit is further configured to add a predetermined weight to the part representing the ID to calculate similarity between the two processing target URLs.

5. The similarity calculation apparatus according to claim 1, wherein the extraction unit is configured to extract the part representing the ID from a part constituting a path or a query of each of the two processing target URLs.

6. A method for calculating similarity, the method comprising:
extracting a part representing an identification (ID) from each of two processing target uniform resource locators (URLs) contained in an operation log;
determining whether or not the part representing the ID is temporarily generated, by using statistical information in operation logs for a predetermined period; and
calculating similarity between the two processing target URLs by excluding the part representing the ID when the part representing the ID is temporarily generated.

7. A computer-readable memory device storing computer-executable program instructions that, when executed by a processor, cause a computer to execute a method comprising:
extracting a part representing an identification (ID) from each of two processing target uniform resource locators (URLs) contained in an operation log;
determining whether or not the part representing the ID is temporarily generated, by using statistical information in operation logs for a predetermined period; and
calculating similarity between the two processing target URLs by excluding the part representing the ID when the part representing the ID is temporarily generated.

8. The method according to claim 6, wherein the determining whether or not the part representing the ID is temporarily generated includes:
determining whether or not the part is temporarily generated by using the number of appearances of the part representing the ID in the operation logs for the predetermined period.

9. The method according to claim 8, wherein the determining whether or not the part representing the ID is temporarily generated includes:
determining that the part representing the ID is not temporarily generated when the part representing the ID appears twice or more over a predetermined time interval in the operation logs for the predetermined period.

10. The method according to claim 6, further comprising:
when the part representing the ID is not determined to be temporarily generated, adding a predetermined weight to the part representing the ID to calculate similarity between the two processing target URLs.

11. The method according to claim 6, wherein the extracting a part representing an ID comprises:
extracting the part representing the ID from a part constituting a path or a query of each of the two processing target URLs.

12. The computer-readable memory device according to claim 7, wherein the determining whether or not the part representing the ID is temporarily generated includes:
determining whether or not the part is temporarily generated by using the number of appearances of the part representing the ID in the operation logs for the predetermined period.

13. The computer-readable memory device according to claim 12, wherein the determining whether or not the part representing the ID is temporarily generated includes:
determining that the part representing the ID is not temporarily generated when the part representing the ID appears twice or more over a predetermined time interval in the operation logs for the predetermined period.

14. The computer-readable memory device according to claim 7, further comprising:
when the part representing the ID is not determined to be temporarily generated, adding a predetermined weight to the part representing the ID to calculate similarity between the two processing target URLs.

15. The computer-readable memory device according to claim 7, wherein the extracting a part representing an ID comprises:
extracting the part representing the ID from a part constituting a path or a query of each of the two processing target URLs.
